(19) United States
(12) Patent Application Publication
(10) Pub. No.: US 2025/0329272 A1
(43) Pub. Date: Oct. 23, 2025

(54) OPHTHALMOLOGICAL TEACHING DEVICE

(71) Applicant: Pocket Retina L.L.C., Washington, DC (US)

(72) Inventor: Sinan AKOSMAN, Washington, DC (US)

(73) Assignee: Pocket Retina L.L.C., Washington, DC (US)

(21) Appl. No.: 19/003,201

(22) Filed: Dec. 27, 2024

Related U.S. Application Data
(60) Provisional application No. 63/636,948, filed on Apr. 22, 2024.

(51) Int. Cl. G09B 23/28

(52) U.S. Cl. CPC G09B 23/28

(57) ABSTRACT

An instructional device has a housing with a housing top wall, a housing bottom wall, and a housing side wall. A viewing opening is located at the housing top wall. A display card having U-shaped bend at the bottom wall. The display card has an inner surface and is contained within the interior space of the housing. Printed matter in the form of actual photograph of an eye, is located on the inner surface of the display card at the bottom wall and the side wall. An attachment apparatus is provided to couple the instructional device to the forehead rest of optical examination equipment to facilitate training on the medical equipment.

### RELATED APPLICATIONS

This application claims the benefit of priority of U.S. Provisional Application No. 63/636,948, filed on Apr. 22, 2024, the entire content of which is relied upon and incorporated herein by reference in its entirety.

### BACKGROUND

U.S. Pat. No. 10,861,352 discloses an ophthalmological teaching aid for an instructor to teach students to identify eye disease. However, there is a need for a teaching device that is more realistic and accurate.

### SUMMARY

An ophthalmologic instructional device has a housing with a housing top wall, a housing bottom wall, and a housing side wall. A viewing opening is located at the housing top wall. A display card having U-shaped bend at the bottom wall. The display card has an inner surface and is contained within the interior space of the housing. Printed matter in the form of actual photograph of an eye, is located on the inner surface of the display card at the bottom wall and the side wall.

This summary is not intended to identify all essential features of the claimed subject matter, nor is it intended for use in determining the scope of the claimed subject matter. It is to be understood that both the foregoing general description and the following detailed description are exemplary and are intended to provide an overview or framework to understand the nature and character of the disclosure.

### BRIEF DESCRIPTION OF THE FIGURES

The accompanying drawings are incorporated in and constitute a part of this specification. It is to be understood that the drawings illustrate only some examples of the disclosure and other examples or combinations of various examples that are not specifically illustrated in the figures may still fall within the scope of this disclosure. Examples will now be described with additional detail through the use of the drawings, in which:

FIG. 1 is a perspective view of an ophthalmologic teaching device in an opened position;

FIG. 2 is a cutaway cross-sectional view of the device of FIG. 1 in an opened position;

FIG. 3 is an exploded view of the device of FIG. 1 in an opened position;

FIG. 4 is a perspective cross-sectional view of the housing of FIG. 1 in a closed position;

FIG. 5A is a side cross-sectional view of the housing of FIG. 1 in a closed position;

FIG. 5B is another embodiment of the housing of FIG. 1 in a closed position;

FIG. 6 is a perspective view of the device of FIG. 1 in a closed position;

FIG. 7 is a side view of the device of FIG. 1 in a closed position;

FIG. 8 is a top view of the device of FIG. 1;

FIG. 9 is a top view of a display card used in the device of FIG. 1;

FIG. 10 is the display card of FIG. 9 in a first folded position;

FIG. 11A is the display card of FIGS. 9, 10 in a second folded position;

FIG. 11B is the display card of FIG. 11A showing the folded tongue section;

FIG. 12 is a bottom housing portion with the display card of FIG. 11 in the second folded position;

FIG. 13 shows the display card of FIG. 9 with printed matter on an outer surface of the display card;

FIG. 14 shows the display card of FIG. 9 with printed matter (photograph of an actual eye) on an inner surface of the display card;

FIG. 15 is an answer key for the display card of FIG. 9;

FIG. 16 is a perspective view of an attachment mechanism for use with the device of FIG. 1;

FIG. 17 is a side view of the attachment mechanism;

FIG. 18 shows an optical medical apparatus in which the device can be utilized, and the attachment mechanism attached to the optical medical apparatus and holding the ophthalmologic teaching device in position on the optical medical apparatus;

FIG. 19 is an enlarged perspective view of the attachment apparatus attached to the optical medical apparatus and holding the ophthalmologic teaching device;

FIG. 20 is a side view of the attachment apparatus just prior to being attached to the optical medical apparatus;

FIG. 21 is a side view of the attachment apparatus attached to the optical medical apparatus;

FIG. 22 is a front view of the attachment apparatus attached to the optical medical apparatus and holding the ophthalmologic teaching device;

FIG. 23 is a perspective corner view of an ophthalmologic teaching device in accordance with a certain embodiment;

FIG. 24 is a perspective cross-section view of the device of FIG. 23;

FIG. 25 is a cross-section side view of the device of FIG. 23;

FIG. 26 is a corner view of the device of FIG. 23;

FIG. 27 is a perspective view of an attachment apparatus;

FIG. 28 is a side view of the attachment apparatus of FIG. 27;

FIG. 29 is a perspective view of the attachment apparatus of FIG. 27 attached to an optical medical apparatus and holding the ophthalmologic teaching device of FIG. 23; and

FIG. 30 is a side view of the attachment apparatus of FIG. 27 attached to an optical medical apparatus and holding the ophthalmologic teaching device of FIG. 23.

The figures show illustrative embodiment(s) of the present disclosure. Other embodiments can have components of different scale. Like numbers used in the figures may be used to refer to like components. However, the use of a number to refer to a component or step in a given figure has a same structure or function when used in another figure labeled with the same number, except as otherwise noted.

### DETAILED DESCRIPTION

In describing the illustrative, non-limiting embodiments illustrated in the drawings, specific terminology will be resorted to for the sake of clarity. However, the disclosure is not intended to be limited to the specific terms so selected, and it is to be understood that each specific term includes all technical equivalents that operate in similar manner to accomplish a similar purpose. Several embodiments are described for illustrative purposes, it being understood that the description and claims are not limited to the illustrated embodiments and other embodiments not specifically shown in the drawings may also be within the scope of this disclosure.

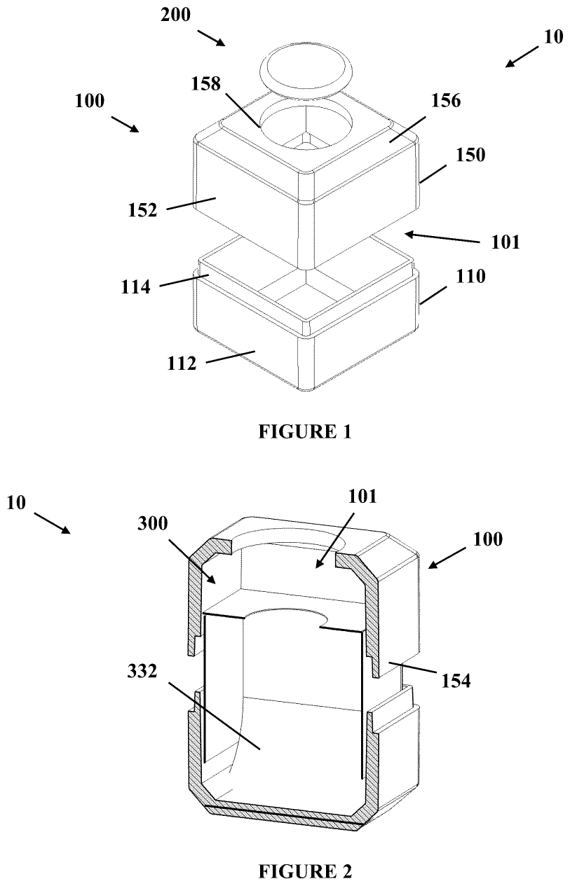

Turning to the drawings, FIGS. 1-2 show an eye or ophthalmologic teaching device 10 in accordance with one non-limiting example embodiment of the present disclosure. The device includes a housing 100, lens 200, and display card or display board 300. The housing 100 forms a complete enclosure with an interior space that receives the display card 300. The lens 200 is received in an opening 158 located at the top of the housing 100. A user looks into the lens 200 to view printed material located on the inside surface 332 of the display card 300.

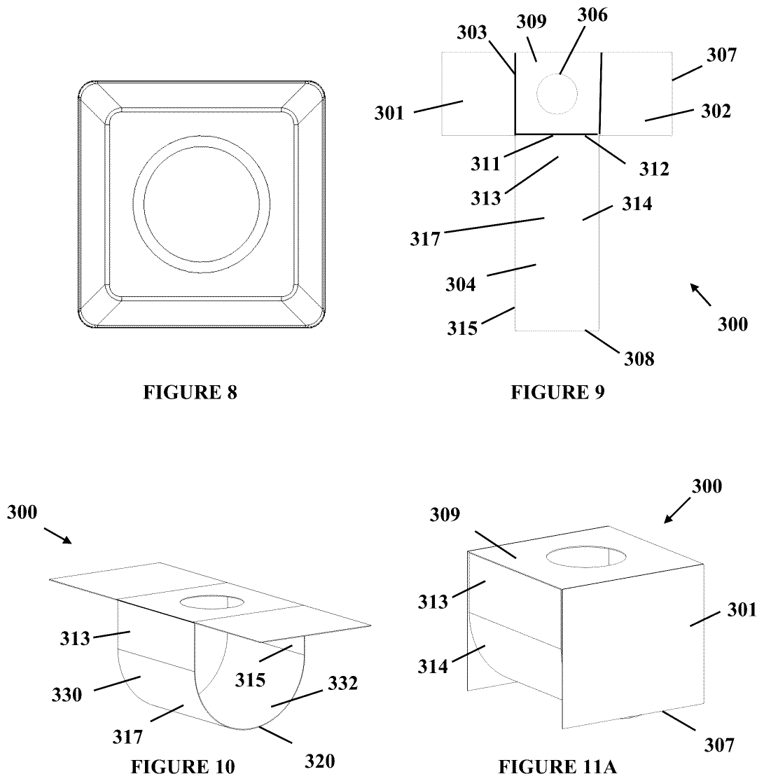

### Housing 100 (FIGS. 1-8)

FIGS. 1-8 show a non-limiting example embodiment of the housing 100 in accordance with the present disclosure. The housing includes a first housing portion 110 and a second housing portion 150. The first housing portion 110 is separate from, and mates with, the second housing portion 150. When coupled together, the housing 100 forms a substantially hollow cube shape having four side walls 120 (see FIG. 4), an open interior space 101, a bottom wall 122 having a distal surface that forms a flat or planar bottom outer surface 102, and a top wall 124 having a proximal surface that forms a flat or planar top outer surface 104. However, other suitable shapes can be utilized.

The first housing portion 110 is the lower or bottom portion of the housing 100. The first housing portion 110 has a first or lower top end 114, a first or lower bottom end 116, and a first or lower middle section 112 between the upper top end 114 and the upper bottom end 116. The lower middle section 112 is flat or planar to form upper side walls 120 of the housing 100 that extend upward from the bottom wall 122 and have an inner lower wall surface and an outer lower wall surface. The first bottom end 116 has the flat or planar bottom outer surface 102. The edges (or lower intersection) of the bottom end 116 (i.e., where the first side walls 120 meet the bottom wall 122) are tapered or angled inward at a bottom angled wall 118, and the corners of the first bottom end 116 are tapered inward and curved to remove any sharp corners and edges that might otherwise injure the user.

In addition, the angled/beveled edge wall 118 has an outer angled wall surface 118a and an inner angled wall surface 118b. The outer angled wall surface 118a that is at a 45-degree angle with respect to the bottom wall 122 and the side wall 120. That allows for the cube to balance on this edge so that the cube rests at a 45-degree angle to the surface of the table. This facilitates viewing of the cube, whereby a viewer can place the cube on a tabletop on its beveled edge and have the cube's top surface angled directly towards the viewer at an arms distance (so you would be sitting at your desk and have the cube an arms-distance away for example).

Without the beveled edge, the viewer would need to be directly overtop the cube, or for example put the cube on its side and crouch down to look directly into it, which are both much less comfortable positions. In further embodiments, the angled wall 118 can have other angles, such as 30-degrees or 67.5-degrees, and the four angled walls 118 can be at different angles than the other edge angled walls 118.

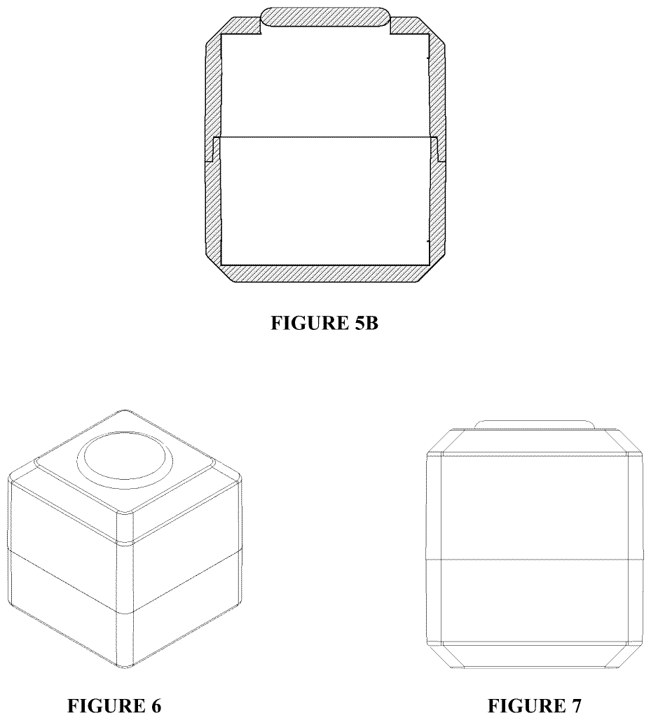

It is noted that the figures show that both the inside and outside of the housing 100 is angled. However, in certain embodiments as shown in FIG. 5B, only the outside wall is beveled, and the inside wall can form sharp corners and sharp edges between the side walls 120 and the top wall 124. That is, the inside side walls 120 are orthogonal to the top wall 124 at their intersection.

The top end 114 is recessed slightly from the outer surface of the middle section 112 to form a lip and thin upright mating element that extends around the top outer perimeter of the first housing portion 110.

The second housing portion 150 is the top or upper portion of the housing 100. The second housing portion 150 has a second or upper bottom end 154, a second or upper top end 156, and a second or upper middle section 152 between the second upper end 154 and the second upper top end 156. The second middle section 152 is flat or planar to form upper side walls 120 of the housing 100 that extend downward from the top wall 124 and have an inner wall surface and an outer wall surface. The second top end 156 has the flat or planar top outer surface 104. The sides (or lower intersection) of the second top end 156 (i.e., where the second side walls 152 meet the top wall) is tapered or angled inward and the corners of the bottom end 156 are tapered inward and curved to remove any sharp corners and edges that might otherwise injure the user. The beveling of the top edge 156 is to make the device more ergonomic to use and provide symmetry with the bottom edge angled wall 118, as well as to create an overall rounded appearance of the cube that loosely imitates the shape of an eyeball. Thus, the user can press up against the device 10 without incurring sharp edges or corners.

It is noted that FIGS. 2, 4, 5A show that both the inside and outside upper and lower angled wall surfaces 118, 156 of the housing 100 are angled. However, in certain embodiments such as shown in FIG. 5B, only the outside wall surface is beveled, and the inside wall surface can form sharp corners and sharp edges between the side walls 120 and the bottom wall 122, and between the side walls 120 and the top wall 124. That is, the inside side walls 120 are orthogonal to the top wall 124 and the bottom wall 122 at their intersection.

In some embodiments, when the housing 100 is closed, the folded display card 300 fits snugly in the interior space 101 of the housing 100, and the six sides of the display card cube just come into contact with the six sides of the housing 100. In particular, the top of the folded display card 300 at the middle section panel 309, touches the inside surface of the housing top wall 124. The distal ends 307 of the side panels 301, and the furthest-most tip 320 of the bent tongue come into contact with the inside surface of the housing bottom wall 122. And the side panels 301 and part of the tongue 313, 315 come into contact with the inside surface of the housing side walls 120. In this way, the display card 300 does not move around within the closed housing 100, to ensure alignment between the lens 200 and the display opening 306 and proper representation of the inside eye printed on the inside surface 332 of the display card 300. In other embodiments, there can be small gaps between the display card 300 and the inside surfaces of the housing 100 to allow for some movement of the display card 300 inside the housing 100, but still provide alignment of the lens 200 and the display opening 306 of the inside eye printed on the inside surface 332 of the display card 300.

The second bottom end 154 is thinned slightly from the inner surface of the second middle section 112 to form a lip and thin upright mating element that extends around the bottom outer perimeter of the second housing portion 150.

Referring to FIGS. 4, 5, when the first and second housing portions 110, 150 are joined, the inner and outer wall surfaces of the first and second housing portions 110, 150 are flush with one another and form continuous inner and outer surfaces.

As best shown in FIGS. 1, 5, a central viewing opening 158 is formed in the top surface 104 of the first housing portion 150.

The housing 100 is completely transparent and can be made, for example of rigid plastic or acrylic. The housing 100 is formed of two separate housing portions 110, 150. The first housing portion 110 can be removably coupled with the second housing portion 150 by pressing the housing portions 110, 150 together, so that the first top end 114 mates with the second bottom end 154, as best shown in FIGS. 5A, 5B, such as by a friction fit. The first housing portion 110 can be removed from the second housing portion 150 by pulling the housing portions 110, 150 apart, to access the interior space and insert/remove the display card 300. However, other suitable configurations can be provided. For example, the housing 100 can be a single piece and the top of the housing 100 can be a removable lid or the bottom of the housing can be a removable bottom cover, which are removed to gain access to the housing interior space 101.

### Lens 200

The lens 200 is received in the viewing opening 158. In certain embodiments, the lens 200 is a magnifying lens that approximates the magnification of a real human eye.

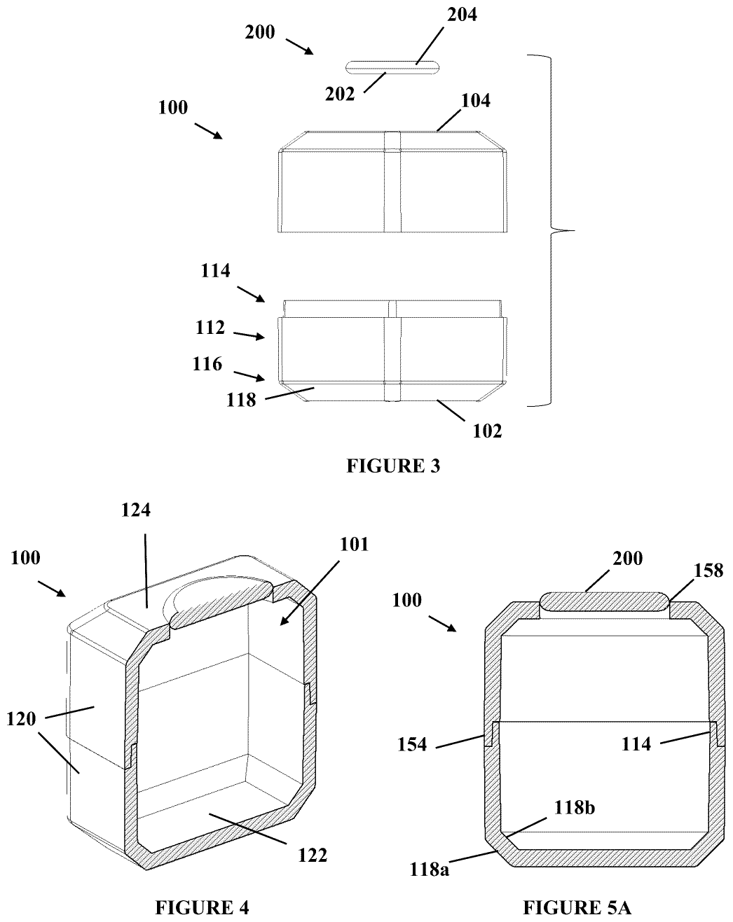

The lens 200 has a distal inward facing surface or portion 202 and a proximal outward facing surface or portion 202 (FIG. 3). In the embodiment shown, the lens 200 can project outward slightly from the top surface 104 of the first housing portion 150 (as best shown in FIGS. 5, 7), though in other embodiments the lens 200 can be flush or recessed within the viewing opening 158 with respect to the top surface 104 of the first housing portion 150. Lenses 200 with higher magnification are thicker, and so they begin to protrude when the thickness becomes greater than the wall thickness of the top surface.

In certain embodiments, the lens 200 is a separate element from the housing 100 and fixed in the viewing opening 158, so that a high-quality lens can be utilized. The lens 200 can be fit to the viewing opening 158 in any suitable manner, such as by a snap-fit or friction fit, or by adhesive or fastener. In some embodiments, the inner circumferential walls of the viewing opening 158 can be curved so that the lens 200 can be snapped (i.e., pressed) into the opening 158 and a snap sound confirms that the lens 200 is properly and reliably retained in the viewing opening 158. In some embodiments, the lens 200 can be fixed with other suitable fastening mechanisms, either removably or permanently, such as by adhesive, clip, clamp, or a cap placed over the lens 200. In addition, the lens 200 can be removed and replaced, for instance if the lens 200 become scratched, or to provide different focal points or magnification that correspond to the printed matter on the display card 300. In other embodiments (see FIGS. 23-28), the lens 200′ is integrally formed with the housing 100′.

### Display Card 300 (FIGS. 9-14)

FIGS. 9-15 show the display card 300 in more detail. The card 300 can be a single piece having a main section 302 (shown at the top in FIG. 9), and a tongue section 304 extending downward from the main section 302. The main section 302 is elongated and in the shape of a rectangle. The main section 302 has a middle panel 309, and two side panels 301. A central display opening 306 is provided at the center of the middle panel 309. A first and second fold line 303 is provided between the main section 302 and the two side panels 301, to assist in folding the side panels 301 downward with respect to the middle panel 309. The two side panels 301 each have a distal edge 307.

The tongue section 304 is elongated and extends downward from the middle panel 309 of the main section 302. The tongue section 304 has a proximal end with a proximal edge 312 that is integral with the middle panel 309 of the main section 302, a distal edge 308, and a tongue middle section 314 between the proximal end and the distal edge 308. A third fold line 311 is provided between the main section 302 and the tongue section 304 to assist in folding the tongue section 309 downward with respect to the middle panel 309.

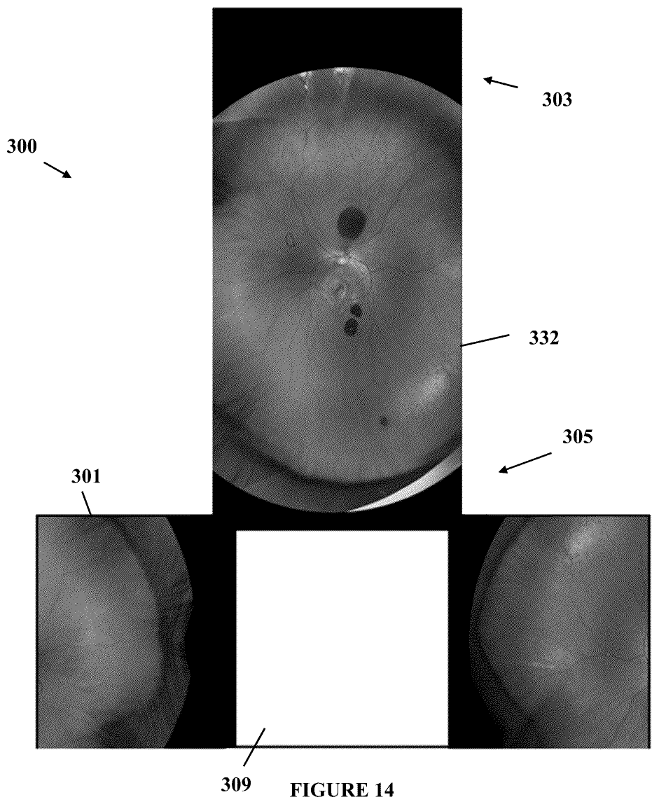

The display card 300 is a paper sheet that is sturdy but flexible and can bend, such as a cardstock. As further shown in FIG. 10, the display card 300 further has an inner surface 332 that faces inwardly, and an outer surface 330 that faces outwardly. As shown in FIGS. 13, 14, printed material can be placed on both the inner surface 332 and the outer surface 330.

FIG. 9 shows the display card 300 in an initial configuration, where the display card 300 is flat and unfolded. As shown, the middle section 309 of the main section 302 has a square shape and has a first edge at the third fold line 311, and a second edge opposite the first edge.

In FIG. 10, the tongue section 304 is folded at the third fold line 311 so that the tongue section 304 extends downward from the first edge of the middle section 309. The tongue section 304 then bends at the middle section 314 to form a U-shape so that the tongue distal edge 308 meets back up with the opposite second edge of the middle panel 309. The tongue distal edge 308 can be coupled to the middle panel 309, such as by an adhesive, tape or fastener at the inner surface 332 of the middle panel 309 and the inner surface 332 of the distal end of the tongue 304. In certain embodiments, the distal end of the tongue 304 (e.g., the distal end of the distal end portion 315) can be folded to provide a tab that facilitates taping the distal edge 308 to the middle panel 309, and allows the entire inner surface of the tongue 304 (beyond the tab) to have printed material. The entirety to the tongue section 304 can be curved. In some embodiments, the tongue section 304 can have a proximal end portion 313, a distal end portions 315, and an intermediate portion 317 therebetween. The proximal and distal end portions 313, 315 (which form the right and left sides of the tongue section when bent) can be flat or straight, and the intermediate portion 317 can be curved, as best shown in FIG. 10.

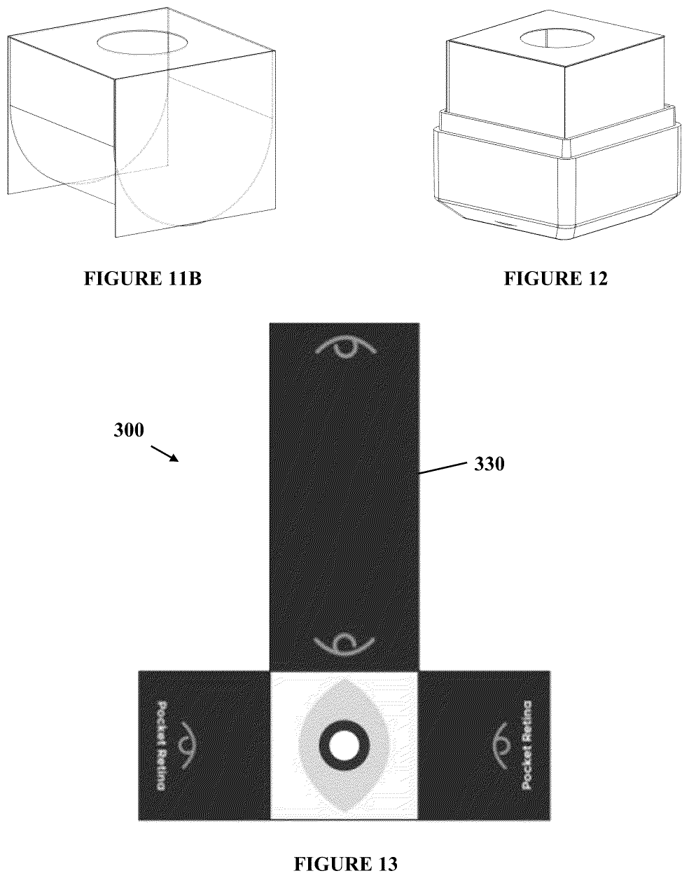

Turning to FIGS. 11A, 11B, the side panels 301 of the main section 302 are then folded downward at the first and second fold lines 303. As best shown in FIG. 11B, the distal edge 307 can be the same length as or longer than the furthest-most portion of the curved U-shaped tongue middle section 314 to block light from entering at the sides, and so that the distal edge 307 contacts the bottom surface and prevents the curved middle section 314 from contacting the bottom surface (or just touching the bottom surface) so that the middle section 314 is not compressed and the printed matter on the inner surface 332 of the middle section distorted. In other embodiments, the distal edge 307 of the side panels 301 can be shorter than the curved tongue middle section 314, so that light can enter into the interior space for better viewing of the printed matter on the inner surface 332 of the display card 300.

As best shown in FIG. 11B, the side panels 301 extend to the outside of the curved middle section 314, so that the side panels 301 come into contact with the curved middle section 314. In this manner, the side panels 301 cannot inadvertently pass into the center of the interior space and block the user from viewing the printed matter on the inner surface 332. In FIG. 11, the folded display card 300 has a cube-shape (with a curved bottom) that is slightly smaller than the interior dimensions of the housing 100, so that the display card 300 fits snugly in the interior space 101 of the closed housing 100.

Now referring to FIG. 12, once the side panels 301 are folded downward, the display card 300 is inserted into the first bottom housing portion 110. The side walls of the first housing portion 110 keep the side panels 301 from raising back upward, so that the side panels 301 need not be fixed to anything. The display card 300 is sized and configured so that it is fully and reliably received in the bottom housing portion 110. In the embodiment where the side panels 301 are the same or greater length than the curved section 314, the distal edge 307 contacts the inside bottom wall of the bottom housing 110, so that the curved section 314 retains its shape.

As best shown in FIG. 2, once the display card 300 is fully inserted into the lower housing 110, the top housing portion 150 is fitted to the lower housing portion 110, with the display card 300 contained in the interior space 101 of the housing 100. The display card 300 is sized and configured so that it just comes into contact with the inner surface of the top wall of the upper housing 150 (or has a small gap between the top (middle panel) of the display card and the inner surface of the top wall) when the upper housing 150 is fully received on the lower housing 110.

The housing 100 and display card 300 are further configured so that the display card 300 is properly aligned with the lens 200 when the housing 100 is closed. As shown, the lens 200 is positioned to view the inner surface 332 of the display card 300 without any obstruction. The lens 200 is aligned in the center viewing opening 158, which is aligned with the center display opening 306, so the user can look through the lens 200 and view the printed matter on the inner surface 332 of the display card 300. The printed matter on the outer surface 330 of the display card 300 is visible through the transparent side walls, top wall, and bottom wall of the housing 100. The housing is transparent so that light enters. However, in some embodiments the walls can be opaque so that no light enters and the display card 300 is sufficiently thick to prevent light from passing through the card 300; and instead the user must shine a light into the interior space 101 through the lens 200 as part of the teaching exercise to better simulate a patient eye.

As shown in FIG. 14, the printed matter placed on the inside surface 332 of the display card 300 can include images of the inside of a patient's eye. The printed matter is located on the inside surface 332 of the side panels 301, as well as the inside surface 332 of the tongue section 304. The U-shaped curved middle tongue section 314 provides an accurate and realistic representation of the inside of a patient's eye, to further enhance teaching (e.g., for an instructor to illustrate to a student, an instructor to test the student, the student to learn and practice). In some embodiments, the curved middle section 314 can have a radius of curvature that simulates that of a patient. Thus, when the user looks through the lens 200, the user can view the printed matter that is on the U-shaped section at the bottom wall of the housing 100 opposite the lens 200 (and curved upward at a portion of two of the opposing side walls), as well as the printed matter that is on the side panels 301 at the other two opposing side walls of the housing 100.

That provides a 3-dimensional image of the simulated patient eye to the user. The printed matter can, for example, simulate a patient condition, such as for example an ocular disease, injury or damage. In addition, different display cards 300 can be used and replaced, each one simulating a different patient condition.

As further illustrated in FIG. 14, the printed matter on the inside surface 332 a photograph of an actual person's real eye, and not black and white line drawings or artistic depictions. And providing images on the inside surface of the side panels 101 provides a 180-degree view for the user. When the user looks inside the device 10, all of the interior surfaces 332 have an image, from the top (depending on how the device 10 is held, the near or far side when viewed by the user) of the tongue 304, the entire way to the bottom (depending on how the device 10 is held, the far or near side when viewed by the user, respectively) of the tongue 304. And, the left and right sides 301 also have printed images. This provides a more realistic experience for the user.

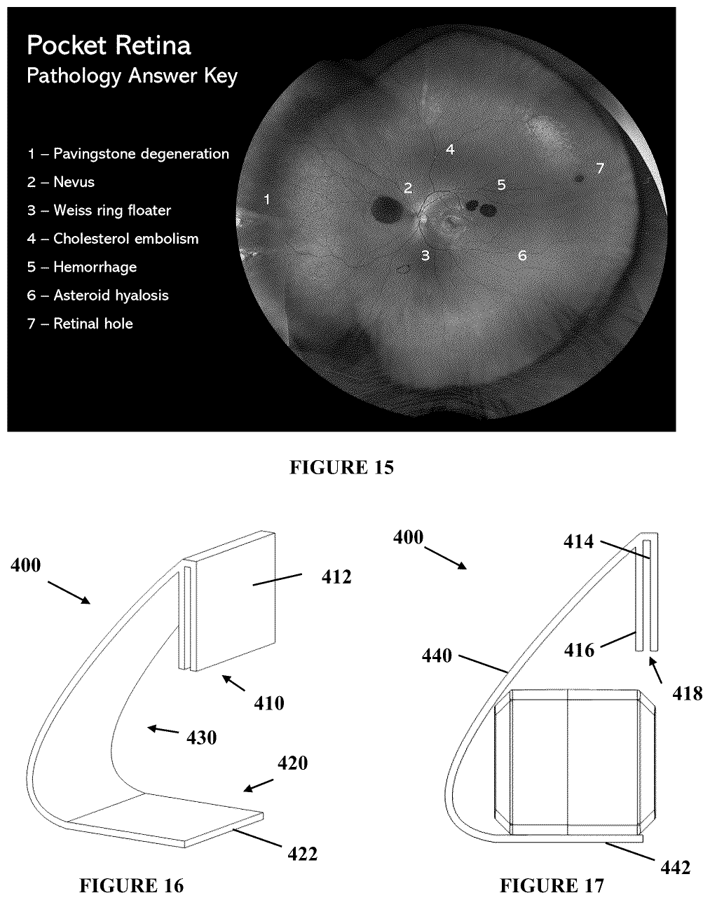

FIG. 15 is an answer key used with the display card 300. The answer key shows the same photographed image of a real eye, and has reference numerals positioned next to specific eye conditions. A table has the reference numeral and the name of the condition. For example, a first eye condition has a reference numeral 1 and the table indicates that condition is pavingstone degeneration.

It is further noted that the U-shape provides a curve from one side wall to an opposite side wall. In other embodiments, the card 300 can be configured so that the entirety of the card is curved, such as to have a 3-dimensional hemisphere having a half-circle cup shape.

The device 10 is sized to best simulate the eye of a patient, and be easy to hold and with a flat bottom to free stand upright, or to rest on one of the angled edge walls 118. In some embodiments, the display card is about 28 mm in height, 32 mm in length, and 32 mm in width, so that the middle panel 309 is a 32 mm×32 mm square. The radius of curvature for the U-shaped is 17 mm, but can be from 15-20 mm.

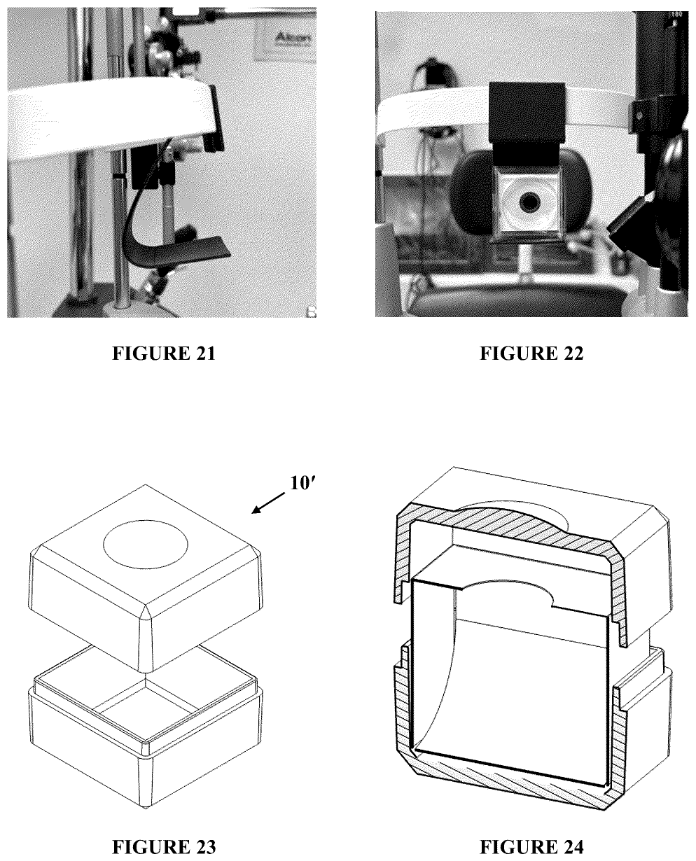

It is further noted that the device 10 can be used with a magnifier and/or light piece, such as a slit lamp, that a physician might ordinarily shine in the eye of a patient. And, as shown in FIGS. 16-22, the device 10 can be held in place by a support adapter that is mounted to a support structure (e.g., table). The support adapter can be, for example, an attachment that hooks onto the forehead rest of a slit lamp and provides a level platform on which the device 10 can rest, thereby positioning the device 10 at approximately the same location that a patient's eye would be during a slit lamp eye examination.

### Attachment Apparatus 400 (FIGS. 16-22)

The ophthalmologic teaching device 10 can be utilized on its own, such as by a medical student or teacher holding the device 10 in his/her hand or placing the device 10 on a table or other support.

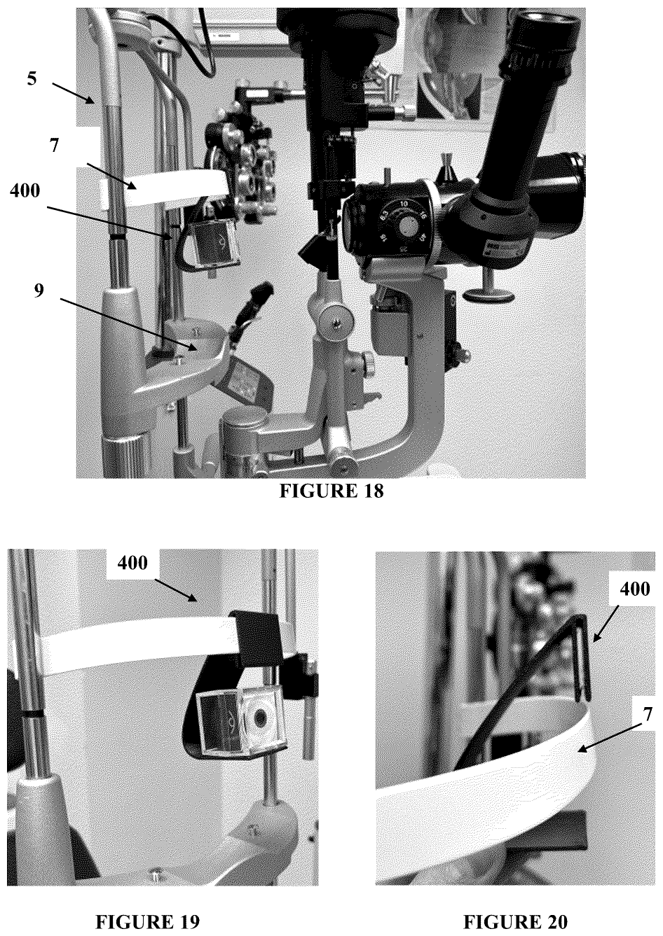

In addition, as shown in FIGS. 18-22, the ophthalmologic teaching device 10 can be utilized with a medical equipment 5. In the non-limiting example embodiment shown, the medical equipment 5 has physician medical devices and patient medical devices. The physician medical devices can include, for example, a vision tester, biomicrosope, lenses, phoropter, condensing lens, head mounted and/or handheld binocular indirect opthalmoscope. The patient medical device includes patient positioning features that are used to properly position the patient with respect to the physician medical equipment.

Here, the patient positioning features include a forehead rest 7 and a chin rest 9. During examination, the patient positions his chin in the chinrest, and presses his forehead forward against the forehead rest 7. In that position, the patient's eyes are within a predetermined distance of the physician medical devices, and directly facing the physician medical devices. The forehead rest 7 is a thin flat elongated strap that extends between two support posts. The strap has a strap length that extends along the longitudinal axis of the strap, a strap width that extends transverse orthogonal to the longitudinal axis, and a strap depth that defines the strap thickness. The forehead rest 7 is fixed between the two support posts to remain in a stat [symbol] osition. The forehead rest 7 is configured to receive a patient's forehead, whereby the strap is curved between the two supports and slightly angled with respect to vertical, as best shown in FIG. 18.

Referring to FIGS. 16-22, an attachment apparatus 400 is provided that attaches the ophthalmologic teaching device 10 to the medical equipment 5. In the embodiment shown, the attachment apparatus 400 is removably coupled to the forehead rest 7. The attachment apparatus 400 has a distal end portion 410, proximal end portion 420 with a leading edge 422, and intermediate portion 430. The attachment apparatus 400 has a fastening mechanism and a positioning mechanism. The fastening mechanism physically and removably couples the attachment apparatus 400 to the medical equipment, and the positioning mechanism receives the ophthalmologic teaching device 10 and positions the ophthalmologic teaching device 10 with respect to the medical equipment 5.

In the example embodiment shown, the fastening mechanism is a clamp or clip 412 having two clip member 414, 416, a first outer clip member 414, and a second inner member 416. The clip members 414, 416 are thin flat plates that extend downward from a distal edge of the distal end 410, substantially parallel to each other and separated to form a clip channel 418 therebetween. The clip channel 418 removably receives the strap 7, and the front face of the outer clip 414 is flat and faces outward toward the user.

Referring to FIG. 20, the attachment apparatus 400 is shown just prior to coupling with the strap 7. The clip channel 418 is aligned with the strap 7, and the attachment apparatus 400 is pressed down so that the strap 7 is received between the clip members 414, 416. The channel 418 can be sized to form a snug or friction fit with the strap 7. In addition, the clip members 414, 416 have a length that is longer than the width of the strap 7, so that the clip members 414, 416 extend the entire width of the strap 7 and beyond, to provide a reliable coupling, though in other embodiments the clip members 414, 416 need not extend the entire width of the strap 7. Though a single clip 412 is shown, it will be readily apparent that multiple clips 412 can be provided.

In other embodiments, a locking clip can be positioned toward the open end of the clip channel 418 with an angled lip on one of the clip members 414, 416 that is biased inward. The angled lip and clip member is pressed outward by the strap 7, and snaps back into position once the strap 7 is fully received in the channel 418, to removably lock the attachment apparatus 400 to the strap 7. To remove the attachment apparatus 400, the outer clip member 414 is pulled outward slightly until the angled lip clears the outer surface of the strap 7, and the attachment apparatus 400 lifted upward.

The positioning mechanism is best shown in the non-limiting example embodiment in FIGS. 16, 17, as an elongated support member 440 that extends from the clip 412 at the distal end of the device 400, to the proximal end portion 420 of the device 400. A shelf 442 is provided at the proximal end portion 420 of the support member 440 and includes the forward edge 422. The support member 440 has a first straight or slight curved section that is straight slightly curved (as shown) to extend downward and rearward from the distal end portion 410 to the intermediate portion 430, then has a second sharply curved section that turns sharply inward from the slight curved section to the third linear shelf section 442, to form a general C-shape.

As best shown in FIG. 17, the intermediate portion of the support member 440 is approximately 45-degrees to the clip members 414, 416, and the shelf 442 is substantially orthogonal to the clip members 414, 416. Thus, the shelf 442 extends outward from the slightly curved section and can be recessed (as shown), flush, or project outward with respect to the clip members 416, 418. The shelf 442 is below the bottommost ends of the clip members 414, 416 to receive the ophthalmologic teaching device 10. The ophthalmologic teaching device 10 can freely rest on the shelf 442, as shown. Or it can be fastened to the shelf 442, such as by a fastener feature on the shelf 442 and the ophthalmologic teaching device 10, for example a loop and hook fastener. As illustrated, the bottom angled edge wall 118 allows for greater space.

In addition, the shelf 442 is thin and has an upper surface and a bottom surface. The bottom surface of the shelf 442 is flat or planar and substantially horizontal, so that it can be placed on a flat surface and stand upright. The upper surface of the shelf 442 has the same shape and size as the side of the device 10, here shown as flat or planar and substantially horizontal, so that the device 10 can be placed on it.

As best shown in FIGS. 18-22, the attachment apparatus 400 positions the ophthalmologic teaching device 10 in the same position (vertical, horizontal, and angular (up/down head tilt)) as a patient's eye would be positioned if an actual patient were being examined. That is, referring to FIG. 18, the ophthalmologic teaching device 10 is vertically positioned from the forehead rest 7 to be vertically aligned with the physical medical device. The ophthalmologic teaching device 10 is also horizontally arranged to be approximately flush with the forehead rest 7 to be at a desired horizontal distance from the physician medical device. And, ophthalmologic teaching device 10 is angled slightly upward with respect to horizontal, to be angularly aligned with the physician medical device. This positioning allows the ophthalmologic teaching device 10 to be viewed by a physician or student, and provide a realistic experience for the physician or student. Thus, as best shown in FIG. 22, the device 10 directly faces the physician medical equipment. In addition, the leading edge 422 is linear and is parallel to the forehead rest 7 and faces orthogonally to the physician medical equipment. The front surface of the device 10 can be aligned with the leading edge 422 to ensure that the device 10 is properly aligned and directly faces the physician medical equipment. In addition, the corners of the shelf 442 can be angled (such as 30-45 degrees) and the device 10 can be aligned with the angled corners to replicate the patient looking left and right.

As further shown, the attachment apparatus 400 is formed as a single one-piece unitary piece. However, the ophthalmologic teaching device 10 can be made of several pieces that are coupled together. And, the ophthalmologic teaching device 10 can be adjustable in the vertical, horizontal, and/or angled with respect to the strap 7. For example, the shelf 442 can be rotationally coupled to the intermediate portion of the support member 440 (or the fastening mechanism can be rotationally coupled to the positioning mechanism) so that the shelf 442 can be moved vertically, horizontally or swiveled left/right with respect to the support member 440. Or to move the device 10 to replicate the patient looking left/right, up/down.

While a single ophthalmologic teaching device 10 is shown in the embodiments of FIGS. 1-22, two devices 10 can be utilized, one simulating a left eye and one simulating a right eye. In addition, the attachment apparatus 400 can be widened to receive two devices 100 that are placed side by side. Moreover, the two devices can be fixedly coupled to one another at a distance (fixed or variable) of an ordinary human, such as by an adjustable length fastener, for example an adjustable rod or rods of different length, or by a hook and loop fastener, clip, clamp or sliding fastener.

It is further noted that the attachment apparatus 400 is shown for removable coupling to a strap 7. In addition, the attachment apparatus 400 is designed to hang downward from the strap 7 with the device 100 positioned below the strap 7. However, the attachment apparatus 400 can be designed differently to couple with different medical equipment, other than as shown and described.

Referring to FIGS. 23-26, an ophthalmologic teaching device 10′ is shown. The ophthalmologic teaching device 10′ is similar to the ophthalmologic teaching device 10 of FIGS. 1-22, except that the lens 200′ is formed integrally with the top surface 104′ of the top housing portion 150′ of the housing 100′. As shown, the top surface 104′ is curved outward, and the inner surface 105′ can be flat to form a single continuous inner top surface, though in certain embodiments the top surface and/or inner surface can have other geometries such as the top surface can be planar and the inner surface can be curved inward, or curved outward, to achieve a desired magnification, index of reflection, light curvature, or other light or optical characteristic. By being integrally formed with the housing 100′, the lens 200′ cannot become inadvertently detached. In addition, the inner top surface is smooth, so that it cannot interfere with the display card 300.

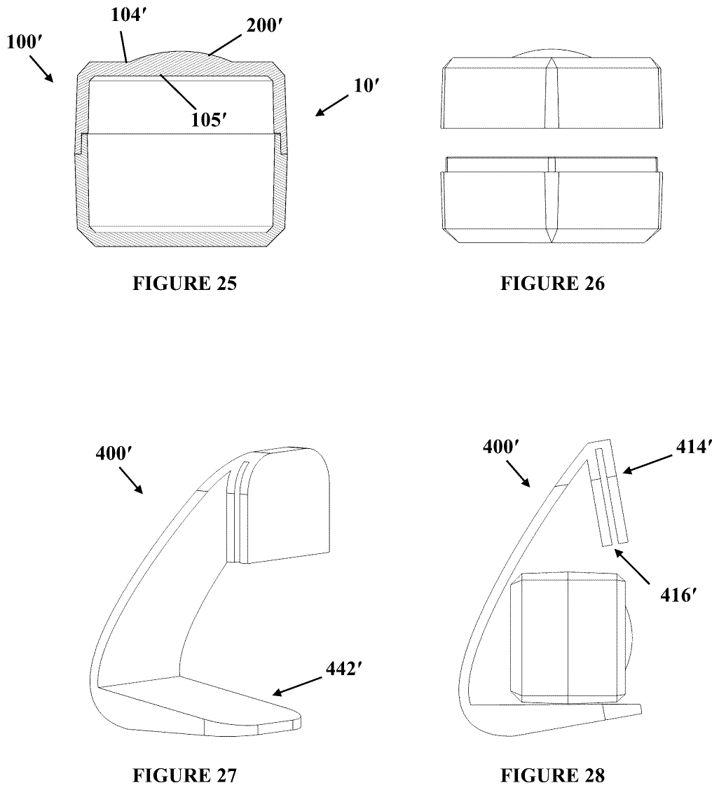

Referring to FIG. 25, the side walls are straight or optionally bowed outward at the middle so that the plastic can be ejected during manufacturing from the molding machine. A straight side wall would form a vacuum and the plastic would get stuck in the mold. The bowed outer walls form a draft angle that enables the plastic to be readily removed from the manufacturing mold.

Turning to FIGS. 27-30, an attachment apparatus 400′ is shown. Here, the clip members 414′, 416′ are angled outward slightly to face slightly upward with respect to vertical, and as compared with FIGS. 16, 17, to better align and mate with the equipment strap. In addition, the clip members 414′, 416′ have top corners that are angled or curved, to be more ergonomic, and avoid injuring a user or equipment. And the outer perimeter edges of the outer clip member 414′ and inner clip member 416′ is curved to avoid a sharp corner or edge that might injure a user or equipment.

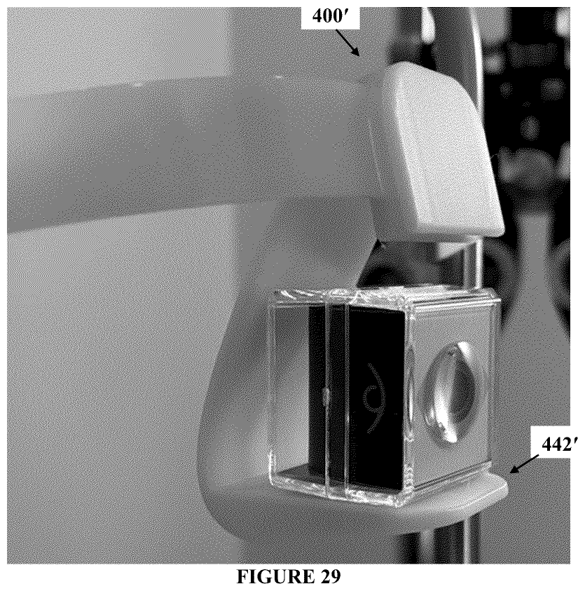

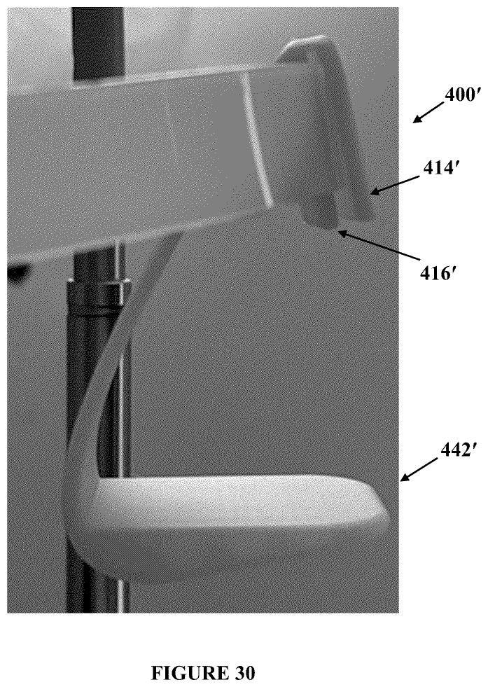

As best shown in FIG. 28, the bottom surface of the shelf 442′ is rounded and tapered inward to be thinner at the front leading edge of the shelf and thicker at the rear training edge of the shelf 442′. This configuration makes the attachment apparatus 400′ easier to grab by the user, and for the user to push it downward to place it on the equipment strap and move it upward to remove it from the equipment strap. In addition, the apparatus 400′ is more upright and less curved at the rear, than the apparatus 400 of FIGS. 16, 17. In addition, this configuration is useful to offset the angle that the head strap has, so that the eye model can remain parallel with the ground. As shown in FIG. 30, the eye model is pointing straight ahead when hooked onto the head strap. This configuration allows for the attachment apparatus 400′ to rest parallel with the plane of the ground when engaged into the equipment strap.

It is further noted that the drawings may illustrate and the description and claims may use several geometric or relational terms and directional or positioning terms, such as ergonomic, between, planar, U-shaped, curved, elongated, curved, rounded, tapered, orthogonal, rectangular, circular, flat, top, bottom, inner, outer, side, upper, lower, distal, and proximal. Those terms are merely for convenience to facilitate the description based on the embodiments shown in the figures, and are not intended to limit the invention. Thus, it should be recognized that the invention can be described in other ways without those geometric, relational, directional or positioning terms. In addition, the geometric or relational terms may not be exact. For instance, walls or surfaces may not be exactly flat but still be considered to be substantially flat because of, for example, roughness of surfaces, tolerances allowed in manufacturing, etc. And, other suitable geometries and relationships can be provided without departing from the spirit and scope of the invention.

Within this specification, the various sizes, shapes and dimensions are approximate and exemplary to illustrate the scope of the invention and are not limiting. The sizes can mean plus or minus 15-20%, or in other embodiments plus or minus 10%, and in other embodiments plus or minus 5%, and plus or minus 1-2%. In addition, while specific dimensions, sizes and shapes may be provided in certain embodiments of the invention, those are simply to illustrate the scope of the invention and are not limiting. Thus, other dimensions, sizes and/or shapes can be utilized without departing from the spirit and scope of the invention.

The foregoing description and drawings should be considered as illustrative only of the principles of the invention. The invention may be configured in a variety of shapes and sizes and is not intended to be limited by the embodiment.

Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention. As used herein, when an element or feature is described as being “configured,” that element or feature is structurally arranged or formed to accomplish the stated purpose.

The foregoing description and drawings should be considered as illustrative only of the principles of the disclosure, which may be configured in a variety of shapes and sizes and is not intended to be limited by the embodiment herein described. Numerous applications of the disclosure will readily occur to those skilled in the art. Therefore, it is not desired to limit the disclosure to the specific examples disclosed or the exact construction and operation shown and described. Rather, all suitable modifications and equivalents may be resorted to, falling within the scope of the disclosure.

1. An instructional device, comprising:
a housing having a housing top wall, a housing bottom wall, and a housing side wall to form a housing interior;
a viewing opening at the housing top wall; and
a display card having a U-shaped bend at the bottom wall, said display card located inside the housing interior and having an inner surface.

2. The instructional device of claim 1, wherein said display card has a left wall and a right wall and a U-shape bend formed between the left wall and the right wall.

3. The instructional device of claim 1 wherein said display card has a U-shape bend at the bottom wall and the side wall.

4. The instructional device of claim 1, further comprising a lens opening in said housing top wall.

5. The instructional device of claim 4, further comprising a separate magnifying lens received in said lens opening.

6. The instructional device of claim 4, further comprising a magnifying lens integrally formed in said lens opening.

7. The instructional device of claim 1, said display card comprising:
a main panel having a square shape with a first edge, a second edge opposite the first edge, a third edge between the first edge and the second edge, and a fourth edge opposite the third edge;
a first side panel extending downward from the first edge of said main panel;
a second side panel extending downward from the second edge of said main panel; and
an elongated panel extending downward in a U-shape from the third edge and the fourth edge.

8. The instructional device of claim 7, wherein said first side panel and said second side panels are square or rectangular shaped and extend along said elongated panel.

9. The instructional device of claim 8, wherein said U-shaped elongated panel block said first side panel and said second side panel from extending into the center of the U-shaped elongated panel.

10. The instructional device of claim 1, wherein said printed matter is a photograph of a real eye.

11. The instructional device of claim 1, further comprising printed matter on the inner surface of said display card at the bottom wall and the side wall.

12. An instructional device comprising:
a housing having a housing top wall, a housing bottom wall, and a housing side wall;
a viewing opening at the housing top wall;
a display card having an inner surface formed at the housing bottom wall and the housing side wall; and
printed matter on the inner surface of said display card at the bottom wall and the side wall.

13. The instructional device of claim 12, wherein said display card has a U-shape bend at the bottom wall.

14. An attachment apparatus, comprising:
a flat support member having a distal end portion with a distal edge and a proximal end portion, a first section extending from the distal end portion rearward, a second sharply curved section, and a third linear shelf portion extending inwardly from said first section at the proximal end portion, said support member forming a general C-shape; and
a clip extending downward from said distal edge of said support member, said clip having a clip channel configured to receive a medical equipment support member.

15. The attachment apparatus of claim 14, said clip having a first clip plate and a second clip plate, the first clip plate substantially parallel to said second clip plate forming the clip channel therebetween.

16. The attachment apparatus of claim 14, said shelf configured to removably receive an ophthalmologic teaching device having a cube-shaped housing and position the ophthalmologic teaching device with respect to the medical equipment support member to simulate a human patient.
